(19) United States
(12) Patent Application Publication
(10) Pub. No.: US 2011/0014316 A1
(43) Pub. Date: Jan. 20, 2011

(54) INJECTION MOLDING DEVICE WITH EJECTION MECHANISM

(75) Inventor: CHIEN-FENG HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/778,133

(22) Filed: May 12, 2010

(30) Foreign Application Priority Data
Jul. 17, 2009 (CN) 200910304473.X

(51) Int. Cl. B29C 45/40

(52) U.S. Cl. 425/556

(57) ABSTRACT

An injection molding device with an ejection mechanism includes a cover, an ejector pin, a housing movably sleeving the ejector pin, and an elastic part placed over the ejector pin. The housing defines a through hole. One end of the ejector pin is fixed to the cover. Two opposite ends of the elastic part resist the cover and the housing respectively. A flange is defined in one end of the ejector pin opposite to the end fixed to the cover, and is configured for covering the through hole. The ejector pin is guided by the through hole to move away from the housing to drive the flange to push a finished product. The elastic part is configured for driving the flange to cover the through hole.

### BACKGROUND

1. Technical Field

The present disclosure relates to an molding devices and, particularly, to an injection molding device with an ejection mechanism.

2. Description of Related Art

Referring to FIG. 1, a cross-sectional view of an ejection mechanism 10 of an injection molding device 11 in the related art, the ejection mechanism 10 is configured for ejecting a finished product 12 from the injection molding device 11. The ejection mechanism 10 includes a cover 101 and an ejector pin 102. One end of the ejector pin 102 is connected to the cover 101, and another end of the ejector pin 102 forms a free end 103, which is a circular platform. When molding, the free end 103 is received in a groove 110 of the injection molding device 11, and is surrounded by the molding material. After the molding material is cooled and sets, an external force is applied on the cover 101 of the ejection mechanism 10, so that, the cover 101 is pushed to drive the ejector pin 102 to eject the finished product 12 from the groove 110.

However, when the finished product 12 is ejected from the groove 110, because the surface of the free end 103 is quite rough, the finished product 12 often adheres to the free end 103, and thus cannot easily separate from the ejector pin 102.

Therefore, what is needed is an injection molding device with an ejection mechanism to overcome the described shortcoming.

### BRIEF DESCRIPTION OF THE DRAWINGS

FIG. 1 is a cross-sectional view of an ejection mechanism of an injection molding device in a related art.

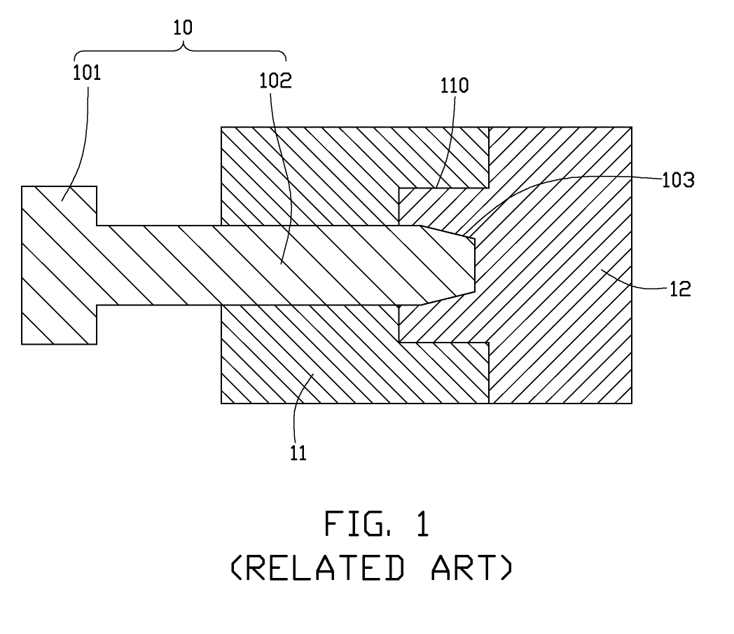

FIG. 2 is a cross-sectional view of an ejection mechanism of an injection molding device in accordance with an exemplary embodiment.

FIG. 3 is another cross-sectional view of the ejection mechanism of the injection molding device of FIG. 2, showing a use state.

FIG. 4 is yet another cross-sectional view of the ejection mechanism of the injection molding device of FIG. 2, showing another use state.

### DETAILED DESCRIPTION

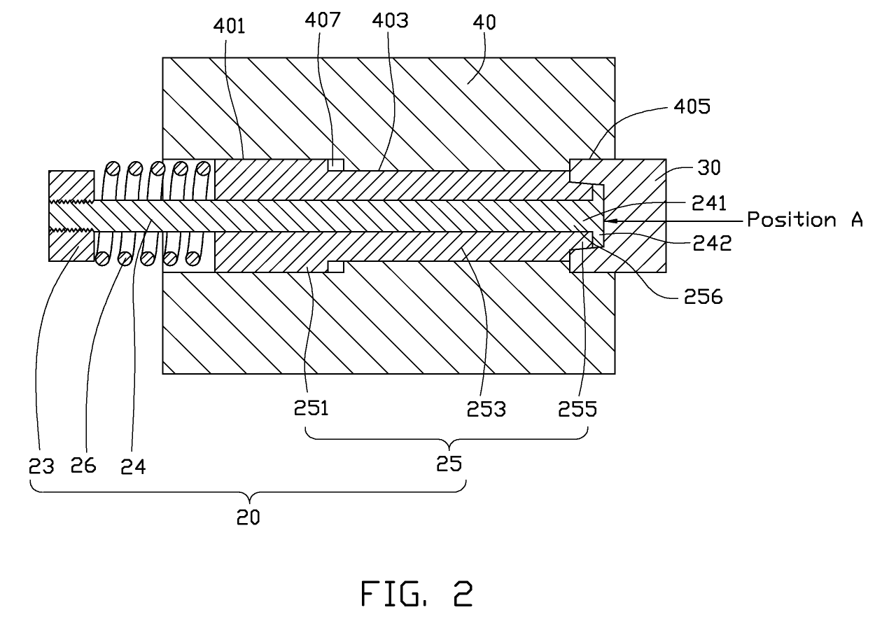

Referring to FIG. 2, an ejection mechanism 20 of an injection molding device is provided. The ejection mechanism 20 is configured for ejecting a finished product 30 from an injection molding device 40. The ejection mechanism 20 includes a cover 23, an ejector pin 24, a housing 25 sleeved on the ejector pin 24, and an elastic part 26 placed over the ejector pin 24. Two ends of the elastic part 26 resist the cover 23 and the housing 25 respectively. One end of the ejector pin 24 is fixed to the cover 23, and, for instance, the ejector pin 24 can be fixed to the cover 23 by screwing. Another end of the ejector pin 24 forms a free end 241. In the embodiment, the elastic part 26 is a spring.

The housing 25 is substantially hollow, stepped cylinder shaped with a through hole 256 defined therein, and includes a first cover body 251, a second cover body 253 connected to the first cover body 251, and a third cover body 255 connected to the second cover body 253. The diameters of the first cover body 251, the second cover body 253, and the third cover body 255 is decreased in sequence with the first cover body 251 having the largest diameter. The third cover body 255 is a substantially hollow cone. In the embodiment, the first cover body 251 and the second cover body 253 are hollow cylinders. In another embodiment, the first cover body 251 and the second cover body 253 may be, for example, hollow rectangular cylinders. The elastic part 26 resists the first cover body 251. A flange 242 is defined at the free end 241 of the ejector pin 24, and is configured for covering the through hole 256. In the embodiment, the first cover body 251 cooperates with the second cover body 253 and the third cover body 255 to form an injection molding machine.

The injection molding device 40 includes a first receiving cavity 401 for receiving the first cover body 251, a second receiving cavity 403 for receiving the second cover body 253, and a third receiving cavity 405 for receiving the third cover body 255. The first receiving cavity 401 communicates with the second receiving cavity 403, and the second receiving cavity 403 communicates with the third receiving cavity 405. The diameter of the second receiving cavity 403 is less than that of the first receiving cavity 401. When the ejection mechanism 20 is in a position A (as shown in FIG. 2), the first cover body 251 is received in the first receiving cavity 401, and forms a limitation cavity 407 with the second receiving cavity 403 and the portion of the second cover body 253 received in the first receiving cavity 401. The diameter of the limitation cavity 407 exceeds that of the second receiving cavity 403. The limitation cavity 407 and the second receiving cavity 403 are configured for receiving the second cover body 253. The third cover body 255 and the finished product 30 are received in the third receiving cavity 405. While molding material (not shown) in the third receiving cavity 405 of the injection molding device 40 is in liquid form (molten), the third cover body 255 and the flange 242 are surrounded by the molding material. After the molding material is cooled to form the finished product 30, the third cover body 255 and the finished product 30 are received in the third receiving cavity 405.

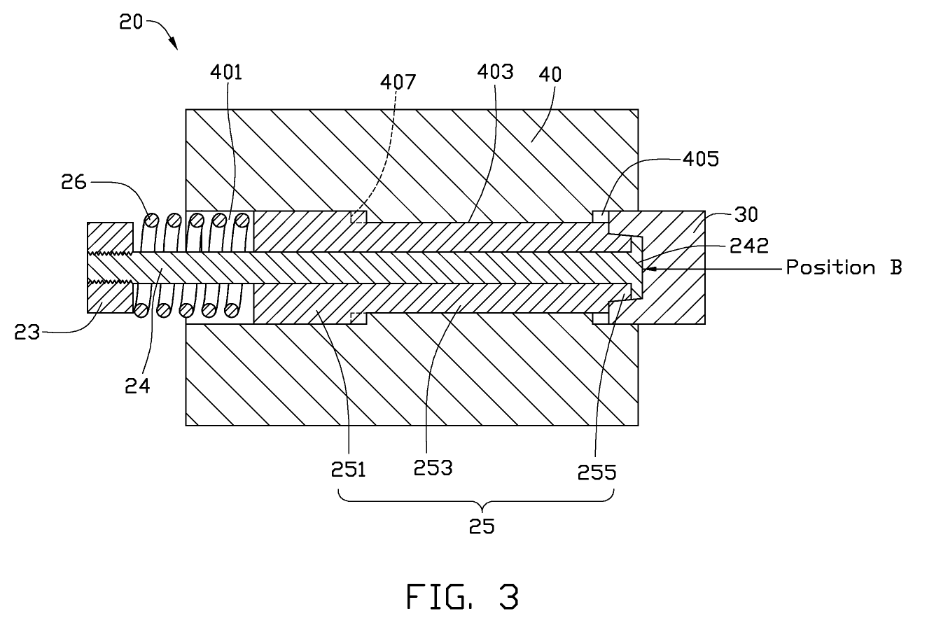

Referring to FIG. 3, when an external force is applied on the cover 23, the elastic part 26 and the ejector pin 24 are driven to move towards the finished product 30, so that the elastic part 26 pushes the housing 25 to move towards the finished product 30, and the flange 242 pushes the finished product 30. When the ejection mechanism 20 is moved from the position A to a position B (as shown in FIG. 3), the first cover body 251 is received in the first receiving cavity 401 and the limitation cavity 407, and the second cover body 253 is received in the second receiving cavity 403 and the third receiving cavity 405, the third cover body 255 cooperates with the flange 242 to eject the finished product 30 from the third receiving cavity 405. Although the finished product 30 is moved relative to the injection molding device 40, the finished product 30 is still attached to the third cover body 255 of the ejection mechanism 20.

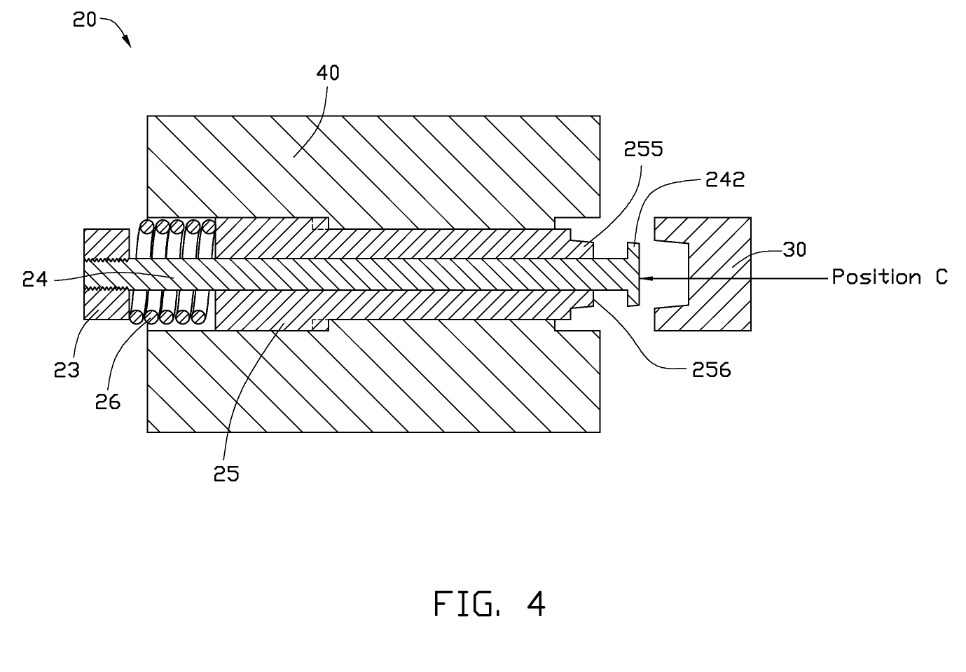

Referring to FIG. 4, the external force is further applied on the cover 23, the elastic part 26 is elastically further deformed by the cover 23, and the flange 242 is thus driven to extend relative to the third cover body 255 away from the cover 23, so that, the ejection mechanism 20 is moved from the position B to a position C (as shown in FIG. 4). The ejector pin 24 is guided by the housing 25 to move away from the housing 25, so that, the flange 242 of the ejector pin 24 is separated from the through hole 256, thereby detaching the finished product 30 from the third cover body 255.

When the external force applied on the cover 23 is removed, the elastic part 26 recoils to drive the flange 242 to be back relative to the third cover body 255, thereby covering the through hole 256 by the flange 242. The ejection mechanism 20 is back to the position B from the position C.

When the cover 23 is pulled by the elastic part 26, the ejector pin 24 is pulled by the cover 23, so that, the elastic part 26 recoils and the housing 25 is pushed by the flange 242, and the ejection mechanism 20 returns to the position A from the position B.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An injection molding device with an ejection mechanism, comprising:
a cover;
an ejector pin, wherein one end of the ejector pin is fixed to the cover;
a housing defining a through hole, the housing movably sleeving the ejector pin via the through hole;
an elastic part placed over the ejector pin, wherein two ends of the elastic part resist the cover and the housing respectively;
wherein, a flange is defined in an end of the ejector pin opposite to the end fixed to the cover, and is configured for covering the through hole, the ejector pin is guided by the through hole to move away from the housing to drive the flange to push a finished product, and the elastic part is configured for driving the flange to cover the through hole.

2. The injection molding device with the ejection mechanism as described in claim 1, wherein the housing comprises a first cover body, a second cover body connected to the first cover body, and a third cover body connected to the second cover body, the diameters of the first cover body, the second cover body, and the third cover body is decreased in sequence with the first cover body having the largest diameter, the third cover body is a substantially hollow cone, and the elastic part resists the first cover body.

3. The injection molding device with the ejection mechanism as described in claim 2, wherein the first cover body cooperates with the second cover body and the third cover body to form an injection molding machine.

4. The injection molding device with the ejection mechanism as described in claim 2, wherein the first cover body and the second cover body are hollow cylinders.

5. The injection molding device with the ejection mechanism as described in claim 1, wherein the ejector pin is fixed to the housing by screwing.

6. The injection molding device with the ejection mechanism as described in claim 1, wherein the elastic part is a spring.

7. The injection molding device with the ejection mechanism as described in claim 2, further comprising a first receiving cavity for receiving the first cover body, a second receiving cavity for receiving the second cover body, and a third receiving cavity for receiving the third cover body.

8. The injection molding device with the ejection mechanism as described in claim 7, wherein the first receiving cavity communicates with the second receiving cavity, and the second receiving cavity communicates with the third receiving cavity.

9. The injection molding device with the ejection mechanism as described in claim 7, wherein the diameter of the second receiving cavity is less than the first receiving cavity.
